(19) United States
(12) Patent Application Publication
(10) Pub. No.: US 2026/0179192 A1
(43) Pub. Date: Jun. 25, 2026

(54) IMAGE PROCESSING METHOD AND APPARATUS, ELECTRONIC DEVICE, AND STORAGE MEDIUM

(71) Applicant: Beijing Zitiao Network Technology Co., Ltd., Beijing (CN)

(72) Inventor: Lang CHEN, Beijing (CN)

(21) Appl. No.: 18/834,592

(22) PCT Filed: Jan. 13, 2023
(86) PCT No.: PCT/CN2023/072089

§ 371 Date: Jul. 30, 2024

(30) Foreign Application Priority Data
Jan. 30, 2022 (CN) 202210114114.3

(51) Int. Cl. G06T 5/70; G06V 10/764; G06V 40/16

(52) U.S. Cl. CPC G06T 5/70; G06V 10/764; G06V 40/16

(57) ABSTRACT

The present disclosure provides an image processing method, apparatus, electronic device, and storage medium. The image processing method comprises: acquiring a target facial image to be processed of a target object; and inputting the target facial image to be processed to a pre-trained target facial processing model to obtain a facial processing target image with a target facial effect. A sample facial image to be processed and a facial processing sample image corresponding to the sample facial image to be processed may be determined according to reference facial images to be processed in a preliminary to-be-processed sample set and facial processing reference images in a preliminary processing effect set; and an initial facial processing model is trained according to the sample facial image to be processed and the facial processing sample image corresponding to the sample facial image to be processed to obtain the target facial processing model.

### CROSS-REFERENCE TO RELATED APPLICATION(S)

This application claims priority to Chinese Patent Application No. 202210114114.3 filed with the China National Intellectual Property Administration on Jan. 30, 2022, the disclosure of which is incorporated herein by reference in its entirety.

### FIELD

The present disclosure relates to the technical field of images, and for example, to an image processing method, apparatus, electronic device, and storage medium.

### BACKGROUND

A facial processing technology is mainly based on a traditional image processing technology, which uses One-click Beauty to directly smooth a facial image to improve the overall brightness and flatness of a face. However, this method will cause significant loss in the resolution of the facial image and lose details of the facial image, thereby resulting a poor beauty effect. Moreover, it is not possible to optimize a plurality of local areas of the facial image, such as removing wrinkles and filling facial depressions.

In order to optimize the plurality of local areas of the facial image, in the related technology, a user usually manually adjusts each local area using an image processing software, such as adjusting a shape of the face and modifying sizes of the eyes. During the adjustment, the user needs to constantly interact with the image processing software and the operations are complicated.

Therefore, there is a technical problem that the automatic refinement processing on the plurality of local areas of the facial image cannot be achieved in the related technology.

### SUMMARY

The present disclosure provides an image processing method, apparatus, electronic device, and storage medium, to achieve the automatic processing on a local area in a facial image, which improves the processing effect on the facial image and lowers the complication of the facial processing.

In a first aspect, the present disclosure provides an image processing method, comprising:
acquiring a target facial image to be processed of a target object; and
inputting the target facial image to be processed to a pre-trained target facial processing model to obtain a facial processing target image with a target facial effect,
wherein the target facial processing model is trained by:
acquiring a plurality of reference facial images to be processed to construct a preliminary to-be-processed sample set, and acquiring a plurality of facial processing reference images with the target facial effect to construct a preliminary processing effect set;
determining, according to the reference facial images to be processed in the preliminary to-be-processed sample set and the facial processing reference images in the preliminary processing effect set, a sample facial image to be processed and a facial processing sample image corresponding to the sample facial image to be processed; and
training an initial facial processing model according to the sample facial image to be processed and the facial processing sample image corresponding to the sample facial image to be processed to obtain the target facial processing model.

In a second aspect, the present disclosure provides an image processing apparatus, comprising:
an acquisition module, configured for acquiring a target facial image to be processed of a target object; and
a processing module, configured for inputting the target facial image to be processed to a pre-trained target facial processing model to obtain a facial processing target image with a target facial effect,
wherein the target facial processing model is trained by:
acquiring a plurality of reference facial images to be processed to construct a preliminary to-be-processed sample set, and acquiring a plurality of facial processing reference images with the target facial effect to construct a preliminary processing effect set;
determining, according to the reference facial images to be processed in the preliminary to-be-processed sample set and the facial processing reference images in the preliminary processing effect set, a sample facial image to be processed and a facial processing sample image corresponding to the sample facial image to be processed; and
training an initial facial processing model according to the sample facial image to be processed and the facial processing sample image corresponding to the sample facial image to be processed to obtain the target facial processing model.

In a third aspect, the present disclosure further provides an electronic device. The electronic device comprises:
one or more processors;
a storage apparatus, configured for storing one or more programs.
wherein the one or more programs, when executed by the one or more processors, cause the one or more processors to implement the image processing method provided by the present disclosure.

In a fourth aspect, the present disclosure further provides a computer-readable storage medium, storing a computer program. The computer program, when executed by a processor, implements the image processing method provided by the present disclosure.

In a fifth aspect, the present disclosure further provides a computer program product, comprising a computer program carried on a non-transitory computer-readable medium, wherein the computer program comprises program codes used for implementing the image processing method provided by the present disclosure.

### BRIEF DESCRIPTION OF THE DRAWINGS

FIG. 1 is a flowchart of an image processing method according to Embodiment I of the present disclosure;

FIG. 2 is a flowchart of training a target facial processing model in an image processing method according to Embodiment II of the present disclosure;

FIG. 3A is a flowchart of training a target facial processing model in an image processing method according to Embodiment III of the present disclosure;

FIG. 3B is a schematic diagram of a process of generating paired facial images according to the Embodiment III of the present disclosure;

FIG. 4 is a flowchart of training a target facial processing model in an image processing method according to Embodiment IV of the present disclosure;

FIG. 5 is a flowchart of an image processing method according to Embodiment V of the present disclosure;

FIG. 6A is a flowchart of an image processing method according to Embodiment VI of the present disclosure;

FIG. 6B is a schematic diagram of the model training based on a preliminary to-be-processed sample set and a preliminary processing effect set according to the Embodiment VI of the present disclosure;

FIG. 7 is a schematic structural diagram of an image processing apparatus according to Embodiment VII of the present disclosure; and

FIG. 8 is a schematic structural diagram of an electronic device according to Embodiment VIII of the present disclosure.

### DETAILED DESCRIPTION OF EMBODIMENTS

The embodiments of the present disclosure will be described below with reference to the accompanying drawings. Although the accompanying drawings show some embodiments of the present disclosure, the present disclosure may be implemented in various forms, and these embodiments are provided for understanding the present disclosure. The accompanying drawings and embodiments of the present disclosure are only used for illustration.

Multiple steps recorded in method implementations of the present disclosure may be executed in different orders and/or in parallel. In addition, the method implementations may comprise additional steps and/or omit the execution of the steps shown. The scope of the present disclosure is not limited in this aspect.

The term “comprise” and its variants as used herein mean widespread inclusion, namely, “comprising but not limited to”. The term “based on” is “based at least in part on”. The term “one embodiment” means “at least one embodiment”. The term “another embodiment” means “at least another embodiment”. The term “some embodiments” means “at least some embodiments”. Relevant definitions of other terms will be given in the description below.

The concepts such as “first” and “second” mentioned in the present disclosure are only used to distinguish different apparatuses, modules, or units, and are not intended to limit the order or interdependence of the functions performed by these apparatuses, modules, or units. The modifications of “one” and “a plurality of” mentioned in the present disclosure are indicative rather than restrictive, and those skilled in the art should understand that unless otherwise stated in the context, they should be understood as “one or more”.

Messages or names of information exchanged between a plurality of apparatuses in the implementations of the present disclosure are only for illustrative purposes and are not intended to limit the messages or the scope of the information.

### Embodiment I

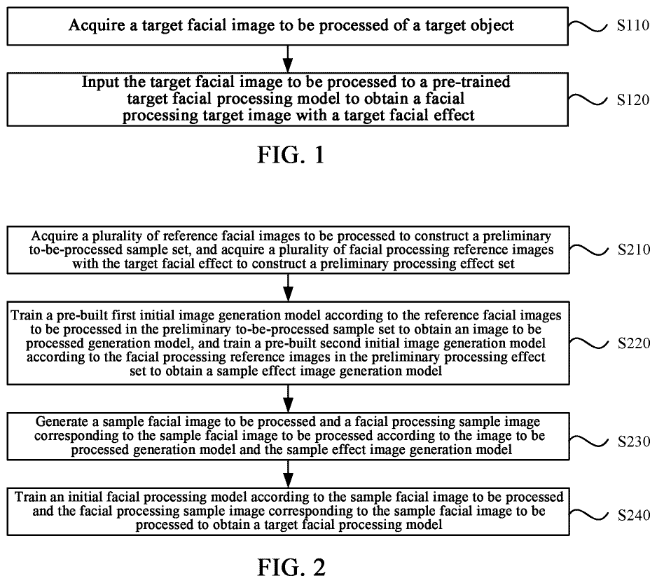

FIG. 1 is a flowchart of an image processing method according to Embodiment I of the present disclosure. This embodiment may be applied to processing a facial image captured currently by a user or a historical facial image currently selected by the user to obtain a processed image containing a target facial effect, such as filling a facial depression area in the facial image, improving the facial firmness in the facial image, reducing the facial firmness, and correcting the facial skin color in the facial image. The method may be performed by an image processing apparatus. The apparatus may be implemented through software and/or hardware and may be configured in a terminal and/or a server to implement the image processing method in the embodiments of the present disclosure.

As shown in FIG. 1, the method of this embodiment may comprise:

S110. Acquire a target facial image to be processed of a target object.

The target object may be an object that requires the facial processing, such as a person, an animal, a model thereof, and the like. The target facial image to be processed may be an image containing a facial area of the target object. There are various ways to acquire the target facial image to be processed. For example, the target facial image to be processed may be a facial image currently captured by a user, an image frame in a video clip currently captured by the user, a historical facial image selected by the user, or the like.

Exemplarily, acquiring the target facial image to be processed of the target object may comprise: in response to a received processing trigger operation used for generating a facial processing target image with a target facial effect, capturing the target facial image to be processed of the target object based on an image capturing device, or receiving the target facial image to be processed of the target object based on an image upload control.

The processing trigger operation may be that the user triggers a processing control displayed on an interface to generate the facial processing target image with the target facial effect. After the processing trigger operation is detected, the image capture control and the image upload control may be displayed on the interface. If a capture trigger operation performed on the image capture control is detected, the target facial image to be processed of the target object may be captured based on the image capture apparatus. If an upload trigger operation performed on the image upload control is detected, the target facial image to be processed of the target object uploaded by the user may be received.

Alternatively, acquiring the target facial image to be processed of the target object may comprise: in response to a received processing trigger operation used for generating a facial processing target image with a target facial effect, capturing a target facial video to be processed of the target object based on an image capture apparatus, and determining the target facial image to be processed based on the target facial video to be processed. In this example, the image capture apparatus or the image upload control is used to acquire the target facial image to be processed that is captured or uploaded by the user. This achieves diversification of the target facial image to be processed and improves the user experience.

In an implementation, considering that there may be redundant areas in the acquired target facial image to be processed other than the facial area, such as a large number of background areas or areas other than the facial area, after the target facial image to be processed of the target object is acquired, the method may further comprises: cutting the target facial image to be processed based on a pre-trained facial detection model, so as to ensure that the cut target facial image to be processed only comprises the facial area.

The facial detection model may locate the facial area in the target facial image to be processed and remove all other areas in the target facial image to be processed except for the facial area. Alternatively, the target facial image to be processed is cut, and an area with a set size that contains the facial area in the target facial image to be processed is reserved, such as an area of 512*512 that contains the facial area. In this way, the redundant areas in the target facial image to be processed may be removed, which reduces the influence of the redundant areas on the processing process and improves the efficiency and accuracy of processing the facial image.

S120. Input the target facial image to be processed to a pre-trained target facial processing model to obtain a facial processing target image with a target facial effect.

The target facial effect is a preset facial processing effect. In this embodiment, the target facial effect may be a beautification or uglification effect for the target facial image to be processed. Exemplarily, the beautification-type target facial effect may be plumping up the face, brightening the skin, lifting and firming the face, correcting the facial shape, removing spots, lightening dark circles, adding eye light, adjusting proportions of the five facial features, i.e., the mouth, nose, ears, eyes and eyebrows, or correcting colors of five facial features. The uglification-type target facial effect may increase the skin age, reduce the sizes of the eyes, reducing the facial firmness, darkening the skin, or the like. The target facial effect may comprise at least one of the above effects.

The pre-trained target facial processing model may output a processed image with the target facial effect. After the target facial image to be processed is acquired, the target facial image to be processed is input to the target facial processing model such that the facial processing target image output by the target facial processing model can be obtained.

In this embodiment, the target facial processing model is trained based on the following steps:

Step 1. Acquire a plurality of reference facial images to be processed to construct a preliminary to-be-processed sample set, and acquire a plurality of facial processing reference images with the target facial effect to construct a preliminary processing effect set. Step 2. Determine a sample facial image to be processed and a facial processing sample image corresponding to the sample facial image to be processed according to the reference facial images to be processed in the preliminary to-be-processed sample set and the facial processing reference images in the preliminary processing effect set. Step 3. Train an initial facial processing model according to the sample facial image to be processed and the facial processing sample image corresponding to the sample facial image to be processed to obtain the target facial processing model.

The reference facial images to be processed may be unprocessed real facial images. The facial processing reference images may be facial images with the target facial effect. A certain number of reference facial images to be processed may be collected to form the preliminary to-be-processed sample set, and a certain number of facial processing reference images may be collected to form the preliminary processing effect set. In order to improve the accuracy of the target facial processing model, the reference facial images to be processed and the facial processing reference images with various angles, various skin colors, or various age groups may be collected.

During the collection, whether an image may be used as a facial processing reference image, that is, whether this image has the target facial effect, may be determined by extracting a structural feature of the image. For example, if the target facial effect is plumping up the face, that is, making the face more three-dimensional and have no depressions, a plurality of corner points of the image may be extracted. If the number of the corner points is smaller than a preset threshold, it may be determined that the image has a plump facial effect and the image may be determined as the facial processing reference image. Alternatively, it is possible to determine, by extracting line features of the image, whether an image is a plump facial image. For example, a cheek depression area, a chin depression area, and a forehead depression area may be segmented from a facial image by using an edge detection algorithm. If a ratio of the cheek depression area to the cheek exceeds a preset cheek depression ratio threshold, it may be determined that the image does not have the target facial effect. Alternatively, if a ratio of the chin depression area exceeds a preset chin depression ratio threshold, it may be determined that the image does not have the target facial effect. Alternatively, if a ratio of the forehead depression area exceeds a preset forehead depression ratio threshold, it may be determined that the image does not have the target facial effect.

In another example, if the target facial effect is removing spots, a facial area in the image other than the five facial features may be determined, and whether the facial area has spots may be determined based on pixel values of a plurality of pixel points of the facial area except for the five facial features. If it is determined that the facial area does not have spots, it may be determined that the image is the facial processing reference image. If the target facial effect is lightening dark circles, associated areas of the eyes may be determined from the image. Whether the image has the target facial effect may be determined based on a difference between a pixel mean value of the associated areas of the eyes and a pixel mean value of other facial areas. For example, if the difference between the pixel mean value of the associated areas of the eyes in the image and the pixel mean value of other facial areas is smaller than a preset difference threshold, it may be determined that the image has the target facial effect.

According to the reference facial images to be processed in the constructed preliminary to-be-processed sample set and the facial processing reference images in the constructed preliminary processing effect set, pairs of sample facial images to be processed and facial processing sample images may be generated.

The sample facial image to be processed may be a reference facial image to be processed in the preliminary to-be-processed sample set, or may be a newly generated unprocessed facial image. Exemplarily, a style-based Generative Adversarial Network (GAN) may be trained using the preliminary to-be-processed sample set, and a new unprocessed facial image may be generated based on the trained GAN. For example, the preliminary to-be-processed sample set may comprise five hundreds of reference facial images to be processed. An image generation network may be trained using the five hundreds of reference facial images to be processed, and two thousands of new facial images to be processed may be generated by the trained image generation network, such that the sample facial images to be processed used for training the target facial processing model may be all or some of the two thousands and five hundreds of images.

The facial processing sample image corresponding to the sample facial image to be processed may be a newly generated facial image with the target facial effect. For example, another image generation network may be trained using the preliminary processing effect set, and a vector corresponding to the sample facial image to be processed may be input to the trained image generation network to obtain the facial processing sample image paired with the sample facial image to be processed. The sample facial image to be processed and the facial processing sample image corresponding to the sample facial image to be processed may be two facial images for the same target object, or may be respective facial images for two similar but different target objects. The image generation networks trained respectively using the preliminary to-be-processed sample set and the preliminary processing effect set may be the same network or different networks. For example, the image generation network may be the style-based GAN, a pixel recursive neural network, a variational autoencoder, and the like.

In this embodiment, the purpose of determining the sample facial image to be processed and the facial processing sample image corresponding to the sample facial image to be processed is as follows: considering that it is difficult to acquire a large number of reference images during the data collection and it is difficult to acquire the pairs of the to-be-processed images and facial images with the target facial effect, in this embodiment the pairs of the sample facial images to be processed and facial processing sample images may be generated by collecting a small number of reference facial images to be processed and a small number of facial processing reference images. This solves the technical problem that it is impossible to acquire a large number of paired facial images in the related technology, provides a data support for the training of the target facial processing model, and thus ensures the prediction accuracy of the trained target facial processing model.

In this embodiment, after each sample facial image to be processed and the facial processing sample image corresponding to each sample facial image to be processed are determined, the constructed initial facial processing model may be trained according to the pairs of the sample facial images to be processed and facial processing sample images. A loss may be calculated according to a prediction result of the initial facial processing model, and network parameters in the initial facial processing model may be adjusted reversely. If a loss function meets a convergence condition, the trained initial facial processing model may be used as the target facial processing model.

The target facial processing model may be a convolutional neural network model such as a residual network and a full convolutional network. Alternatively, the target facial processing model may be a trained generative model in a generative adversarial network model.

In an implementation, the initial facial processing model may comprise a processing effect generation model and a processing effect discrimination model. An initial facial processing model is trained according to the sample facial images to be processed and the facial processing sample images corresponding to the sample facial images to be processed to obtain the target facial processing model, which may comprise the following steps:

Step 1. Inputting the sample facial image to be processed to the processing effect generation model to obtain a processing effect generation image. Step 2. Adjusting the processing effect generation model according to the sample facial image to be processed, the processing effect generation image, and the facial processing sample image corresponding to the sample facial image to be processed. Step 3. Determining whether to stop adjusting the processing effect generation model according to a discrimination result for the processing effect generation image obtained by the processing effect discrimination model, and using the processing effect generation model obtained at the end of the adjustment as the target facial processing model.

The processing effect generation model may be a generator in the initial facial processing model, and the processing effect discrimination model may be a discriminator in the initial facial processing model. The processing effect generation model may generate a facial image, namely, the processing effect generation image, which is obtained by adding the target facial effect to the sample facial image to be processed.

In this implementation, the loss function may be calculated according to the processing effect generation image that is output by the processing effect generation model, the input sample facial image to be processed, and the facial processing sample image corresponding to the sample facial image to be processed. The internal parameters of the processing effect generation model are adjusted based on a result of the calculation of the loss function.

The processing effect generation image output by the processing effect generation model may also be input to the processing effect discrimination model. The processing effect discrimination model may discriminate the processing effect generation image according to the facial processing sample image corresponding to the sample facial image to be processed; output a probability that the processing effect generation image and the facial processing sample image belong to the same category, i.e., output a discrimination result of the processing effect generation image; and determine, according to the discrimination result, whether to continue to adjust the processing effect generation model.

A value of the discrimination result may be [0,1], where 0 indicates that the processing effect generation image and the facial processing sample image do not belong to the same category, that is, the processing effect generation image is “false” and the processing effect is poor, and 1 indicates that the processing effect generation image and the facial processing sample image belong to the same category, that is, the processing effect generation image is “true” and the processing effect is good. For example, if the discrimination result is greater than a preset discrimination threshold, the parameter adjustment performed on the processing effect generation model may be terminated. Alternatively, if the number of times that the discrimination result is greater than the preset discrimination threshold exceeds a preset number of times, the parameter adjustment performed on the processing effect generation model may be terminated.

In this implementation, the processing effect generation model is reversely adjusted using the processing effect generation image output by the processing effect generation model and the discrimination result of the processing effect discrimination model for the processing effect generation image. This achieves the accurate training of the target facial processing model. Compared to a convolutional neural network, the generative adversarial target facial processing model can improve the accuracy of processing the facial image.

In the above steps, adjusting the processing effect generation model using the sample facial image to be processed, the processing effect generation image, and the facial processing sample image may further comprise facial high-dimensional semantic feature correction and facial low-dimensional textural feature correction.

In other words, adjusting the processing effect generation model according to the sample facial image to be processed, the processing effect generation image, and the facial processing sample image corresponding to the sample facial image to be processed may comprise: determining a first facial feature loss between the sample facial image to be processed and the processing effect generation image, and determining a second facial feature loss between the processing effect generation image and the facial processing sample image corresponding to the sample facial image to be processed; and adjusting the processing effect generation model according to the first facial feature loss and the second facial feature loss.

The first facial feature loss may be a loss between an input and an output of the processing effect generation model, and the second facial feature loss may be a loss between a label corresponding to an input of the processing effect generation model and an output of the processing effect generation model. Adjusting the processing effect generation model according to the first facial feature loss and the second facial feature loss may comprise: adjusting the processing effect generation model with an adjustment termination condition that the first facial feature loss is less than a first preset loss threshold and the second facial feature loss is less than a second preset loss threshold.

The purpose of setting the adjustment termination condition that the first facial feature loss is less than the first preset loss threshold and the second facial feature loss is less than the second preset loss threshold is to reduce a difference between the input and the output of the processing effect generation model and ensure that the initial facial information is reserved on the processed facial image as much as possible while maintaining the processing effect of the processing effect generation model.

In another implementation, adjusting the processing effect generation model according to the first facial feature loss and the second facial feature loss may further comprise: calculating a total loss based on the first facial feature loss, a weight corresponding to the first facial feature loss, the second facial feature loss, and a weight corresponding to the second facial feature loss; and adjusting the processing effect generation model based on the total loss.

In this implementation, the processing effect generation model is adjusted by calculating the first facial feature loss and the second facial feature loss, which achieves the facial high-dimensional semantic feature correction and the facial low-dimensional textural feature correction. The processing accuracy of the processing effect generation model is improved and in the meantime it is ensured that the initial facial information is reserved on the processed facial image as much as possible, and severe distortion of the facial image after processing is avoided.

According to the technical solutions of this embodiment, by acquiring a target facial image to be processed of a target object, and inputting the target facial image to be processed to a pre-trained target facial processing model to obtain a facial processing target image with a target facial effect, the sample facial image to be processed and the facial processing sample image corresponding to the sample facial image to be processed may be determined according to reference facial images to be processed in a preliminary to-be-processed sample set and facial processing reference images in a preliminary processing effect set; and thus training a target facial processing model according to the sample facial image to be processed and the facial processing sample image corresponding to the sample facial image to be processed, the trained target facial processing model can automatically process local facial areas, which improves the effect of processing the facial image and lowers the complication of processing the facial image.

### Embodiment II

FIG. 2 is a flowchart of training a target facial processing model in an image processing method according to Embodiment II of the present disclosure. In this embodiment, based on any technical solution of the embodiments of the present disclosure, determining a sample facial image to be processed and a facial processing sample image corresponding to the sample facial image to be processed according to the reference facial images to be processed in the preliminary to-be-processed sample set and the facial processing reference images in the preliminary processing effect set may comprise: training a pre-built first initial image generation model according to the reference facial images to be processed in the preliminary to-be-processed sample set to obtain an image to be processed generation model; training a pre-built second initial image generation model according to the facial processing reference images in the preliminary processing effect set to obtain a sample effect image generation model; and generating the sample facial image to be processed and the facial processing sample image corresponding to the sample facial image to be processed according to the image to be processed generation model and the sample effect image generation model, wherein the first initial image generation model and the second initial image generation model are style-based generative adversarial networks. As shown in FIG. 2, the method for training the target facial processing model provided in this embodiment comprises the following steps:

S210. Acquire a plurality of reference facial images to be processed to construct a preliminary to-be-processed sample set, and acquire a plurality of facial processing reference images with the target facial effect to construct a preliminary processing effect set.

S220. Train a pre-built first initial image generation model according to the reference facial images to be processed in the preliminary to-be-processed sample set to obtain an image to be processed generation model, and train a pre-built second initial image generation model according to the facial processing reference images in the preliminary processing effect set to obtain a sample effect image generation model.

The first initial image generation model and the second initial image generation model are style-based generative adversarial networks. Exemplarily, the style-based generative adversarial networks may be style-based generators (StyleGANs). The first initial image generation model and the second initial image generation model may also use unsupervised neural networks.

The first initial image generation model may comprise a generation network and a discrimination network. Exemplarily, the training process of the image to be processed generation model may be as follows: firstly, generating, using the generation network, a plurality of simulated facial images to be processed for training a discriminator; acquiring a label (for example, 0 indicates “false”) for each simulated facial images to be processed and a label (for example, 1 indicates “true”) for each reference facial image to be processed; and forming a training set for training the discrimination network based on the simulated facial images to be processed, the reference facial images to be processed, the labels corresponding to the simulated facial images to be processed, and the labels corresponding to the reference facial images to be processed. In the training process of the discrimination network, the discrimination network may determine, according to the input simulated facial image to be processed and the reference facial image to be processed, a probability that the simulated facial image to be processed and the reference facial image to be processed belong to the same category, that is, a probability that the simulated facial image to be processed is true. Alternatively, the discrimination network may determine, according to two input reference facial images to be processed, a probability that the two reference facial images to be processed belong to the same category.

After the training of the discrimination network is complete, the purpose of training the generation network is to enable the generation network to generate a facial image to be processed as realistic as possible. The training of the generation network may be as follows: generating, using the generation network, a plurality of simulated facial images to be processed again; inputting the newly generated simulated facial images to be processed to the discrimination network; and adjusting the generation network reversely based on the discrimination results for the simulated facial images to be processed obtained by the discrimination network until a discrimination result of the discrimination network for a simulated facial image to be processed generated by the generation network is true, and thus obtaining the image to be processed generation model.

In this embodiment, the second initial image generation model may also comprise a generation network and a discrimination network. The training process of the second initial image generation model may be as follows: generating, using the generation network, a plurality of simulated processed facial images for training the discriminator; training the discrimination network based on the simulated processed facial images, the facial processing reference images, labels corresponding to the simulated processed facial images, and labels corresponding to the facial processing reference images; and then generating, using the generation network, a plurality of simulated processed facial images again, inputting the newly generated simulated processed facial images to the discrimination network, and adjusting the generation network based on the discrimination results of the discrimination network for the simulated processed facial images to obtain the sample effect image generation model.

S230. Generate the sample facial image to be processed and the facial processing sample image corresponding to the sample facial image to be processed according to the image to be processed generation model and the sample effect image generation model.

After the image to be processed generation model and the sample effect image generation model are trained, the sample facial image to be processed may be generated using the image to be processed generation model, and the facial processing sample image corresponding to the sample facial image to be processed may be generated using the sample effect image generation model.

Exemplarily, a random noise (namely, a random vector) may be introduced into the image to be processed generation model, such that the sample facial image to be processed that is output by the image to be processed generation model and corresponds to the random noise can be obtained. Furthermore, the same random noise is introduced into the sample effect image generation model, such that the facial processing sample image corresponding to the random noise can be obtained. At this time, the sample facial image to be processed that is output by the image to be processed generation model is paired with the facial processing sample image that is output by the sample effect image generation model.

The sample facial image to be processed and the facial processing sample image corresponding to the sample facial image to be processed may be obtained by respectively inputting the same vector to the image to be processed generation model and the sample effect image generation model. In this way, a large number of sample facial images to be processed and a large number of facial processing sample images respectively paired with the sample facial images to be processed may be determined, which expands the sample set for training the target facial processing model.

Since the sample facial images to be processed may also be the reference facial images to be processed in the preliminary to-be-processed sample set, the reference facial images to be processed in the preliminary to-be-processed sample set may also be directly determined as the sample facial images to be processed, and the vectors corresponding to the reference facial images to be processed may be input to the sample effect image generation model.

S240. Train an initial facial processing model according to the sample facial image to be processed and the facial processing sample image corresponding to the sample facial image to be processed to obtain the target facial processing model.

According to the technical solutions of this embodiment, the style-based generative adversarial network is trained using the reference facial images to be processed in the preliminary to-be-processed sample set to obtain the image to be processed generation model, and the style-based generative adversarial network is trained using the facial processing reference images in the preliminary processing effect set to obtain the sample effect image generation model. Then the sample facial image to be processed and the facial processing sample image corresponding to the sample facial image to be processed are generated according to the image to be processed generation model and the sample effect image generation model. This achieves the expansion of training data of the target facial processing model, solves the technical problem that a large number of paired to-be-processed images and facial processing images cannot be acquired in the related technology, and improves the processing accuracy of the target facial processing model.

### Embodiment III

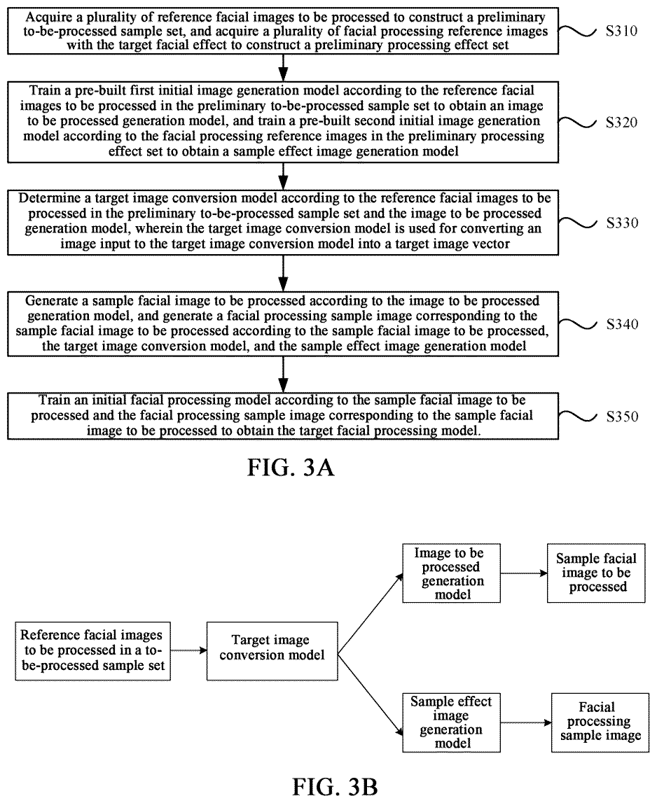

FIG. 3A is a flowchart of training a target facial processing model in an image processing method according to Embodiment III of the present disclosure. In this embodiment, based on any technical solution of the embodiments of the present disclosure, generating the sample facial image to be processed and the facial processing sample image corresponding to the sample facial image to be processed according to the image to be processed generation model and the sample effect image generation model may comprise: determining a target image conversion model according to the reference facial images to be processed in the preliminary to-be-processed sample set and the image to be processed generation model, wherein the target image conversion model is used for converting an image input to the target image conversion model into a target image vector; and generating the sample facial image to be processed according to the image to be processed generation model, and generating the facial processing sample image corresponding to the sample facial image to be processed according to the sample facial image to be processed, the target image conversion model, and the sample effect image generation model. As shown in FIG. 3A, the method for training the target facial processing model provided in this embodiment comprises the following steps:

S310. Acquire a plurality of reference facial images to be processed to construct a preliminary to-be-processed sample set, and acquire a plurality of facial processing reference images with the target facial effect to construct a preliminary processing effect set.

S320. Train a pre-built first initial image generation model according to the reference facial images to be processed in the preliminary to-be-processed sample set to obtain an image to be processed generation model, and train a pre-built second initial image generation model according to the facial processing reference images in the preliminary processing effect set to obtain a sample effect image generation model.

The first initial image generation model and the second initial image generation model are style-based generative adversarial networks.

S330. Determine a target image conversion model according to the reference facial images to be processed in the preliminary to-be-processed sample set and the image to be processed generation model, wherein the target image conversion model is used for converting an image input to the target image conversion model into a target image vector.

In this embodiment, the purpose of converting the image into the target image vector using the target image conversion model is to acquire a vector corresponding to an image to be paired, such that the vector corresponding to the image may be input to the image to be processed generation model and the sample effect image generation model to obtain a pair of the sample facial image to be processed and the facial processing sample image. The image to be paired may be a reference facial image to be processed in the preliminary to-be-processed sample set, or an image generated by the image to be processed generation model.

The target image conversion model may be trained using the preliminary to-be-processed sample set and the image to be processed generation model. Exemplarily, determining the target image conversion model according to the reference facial images to be processed in the preliminary to-be-processed sample set and the image to be processed generation model may comprise the following steps:

Step 1. Input the reference facial images to be processed in the preliminary to-be-processed sample set to an initial image conversion model to obtain model conversion vectors. Step 2. Input the model conversion vectors to the image to be processed generation model to obtain model-generated images corresponding to the model conversion vectors. Step 3. Perform parameter adjustment on the initial image conversion model according to a loss between the model-generated images and the reference facial images to be processed that are input to the initial image conversion model and correspond to the model-generated images, so as to obtain the target image conversion model.

In the above exemplary steps, by inputting the reference facial images to be processed to the constructed initial image conversion model, the model conversion vectors which are output by the initial image conversion model and correspond to the reference facial images to be processed may be obtained. The model conversion vectors are then input to the trained image to be processed generation model to obtain the model-generated images corresponding to the model conversion vectors. Finally, the loss function is calculated using the reference facial images to be processed and the model-generated images, and parameters of the initial image conversion model are adjusted according to a result of the calculation of the loss function until a training termination condition is satisfied. The training termination condition may be that the loss between the reference facial images to be processed and the model-generated images converges and approaches zero, that is, the model-generated images output by the image to be processed generation model are as close as possible to the reference facial images to be processed in the preliminary to-be-processed sample set.

In the above steps, the reference facial images to be processed are input to the initial image conversion model, and the model conversion vectors output by the initial image conversion model are input to the image to be processed generation model; and the parameter adjustment is performed on the initial image conversion model according to the loss between the reference facial images to be processed and the model-generated images output by the image to be processed generation model. This achieves the accurate training of the target image conversion model and improves the precision of the image vector output by the target image conversion model, thereby improving the precision of pairing the sample facial images to be processed and facial processing sample images.

S340. Generate the sample facial image to be processed according to the image to be processed generation model, and generate the facial processing sample image corresponding to the sample facial image to be processed according to the sample facial image to be processed, the target image conversion model, and the sample effect image generation model.

It may be that the sample facial image to be processed is generated using the image to be processed generation model, and the sample facial image to be processed is input to the target image conversion model to obtain the target image vector corresponding to the sample facial image to be processed; and the target image vector is input to the sample effect image generation model to generate the facial processing sample image corresponding to the sample facial image to be processed.

In another implementation, generating the sample facial image to be processed according to the image to be processed generation model, and generating the facial processing sample image corresponding to the sample facial image to be processed according to the sample facial image to be processed, the target image conversion model, and the sample effect image generation model may also comprise: inputting the reference facial image to be processed to the target image conversion model to obtain a target image vector corresponding to the reference facial image to be processed; inputting the target image vector to the image to be processed generation model to obtain the sample facial image to be processed; and inputting the target image vector to the sample effect image generation model to obtain the facial processing sample image corresponding to the sample facial image to be processed.

That is, as shown in FIG. 3B, a schematic diagram of a process of generating paired facial images is illustrated. The reference facial images to be processed in the preliminary to-be-processed sample set are input to the target image conversion model to obtain the target image vectors corresponding to the reference facial images to be processed; and the target image vectors are respectively input to the image to be processed generation model and the sample effect image generation model to obtain the sample facial image to be processed and the facial processing sample image corresponding to the sample facial image to be processed.

With this implementation, the accurate construction of the paired facial images is achieved, and thus the training data of the target facial processing model can be determined, thereby solving the technical problem that the paired facial images cannot be acquired in the related technology.

S350. Train an initial facial processing model according to the sample facial image to be processed and the facial processing sample image corresponding to the sample facial image to be processed to obtain the target facial processing model.

According to the technical solutions of this embodiment, the target image conversion model that can convert an image into a vector is determined using the reference facial images to be processed in the preliminary to-be-processed sample set and the image to be processed generation model. The sample facial image to be processed and the facial processing sample image corresponding to the sample facial image to be processed are generated using the target image conversion model, the image to be processed generation model, and the sample effect image generation model. This achieves the automatic acquisition of the paired facial images and solves the technical problem that a large amount of paired data cannot be acquired in the related technology. Furthermore, it is not necessary to select facial images that can be paired, such that the development cost is reduced.

### Embodiment IV

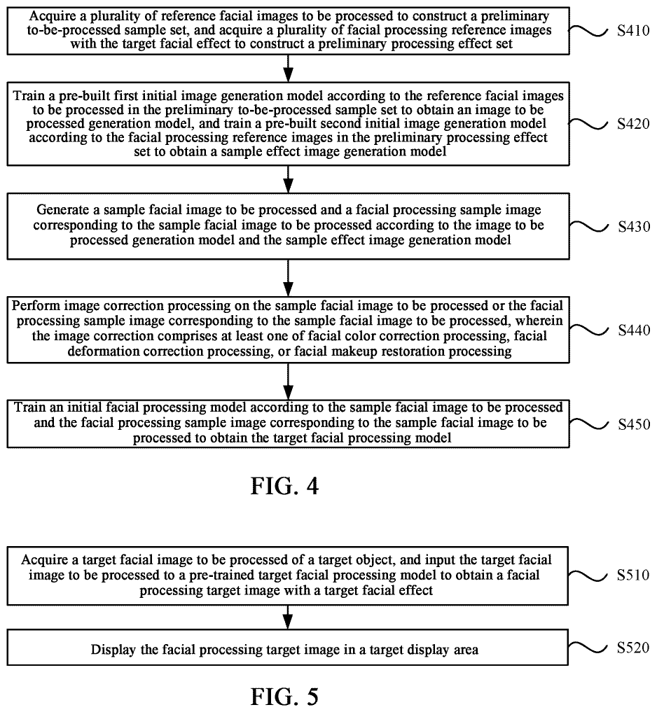

FIG. 4 is a flowchart of training a target facial processing model in an image processing method according to Embodiment IV of the present disclosure. In this embodiment, based on any technical solution of the embodiments of the present disclosure, the method further comprises, prior to training the initial facial processing model according to the sample facial image to be processed and the facial processing sample image corresponding to the sample facial image to be processed: performing the image correction processing on the facial processing sample image corresponding to the sample facial image to be processed according to the sample facial image to be processed, wherein the image correction comprises at least one of facial color correction processing, facial deformation correction processing, or facial makeup restoration processing. As shown in FIG. 4, the method for training the target facial processing model provided in this embodiment comprises the following steps:

S410. Acquire a plurality of reference facial images to be processed are acquired to construct a preliminary to-be-processed sample set, and acquire a plurality of facial processing reference images with the target facial effect to construct a preliminary processing effect set.

S420. Train a pre-built first initial image generation model according to the reference facial images to be processed in the preliminary to-be-processed sample set to obtain an image to be processed generation model, and train a pre-built second initial image generation model according to the facial processing reference images in the preliminary processing effect set to obtain a sample effect image generation model.

S430. Generate the sample facial image to be processed and the facial processing sample image corresponding to the sample facial image to be processed according to the image to be processed generation model and the sample effect image generation model.

S440. Perform image correction processing on the sample facial image to be processed or the facial processing sample image corresponding to the sample facial image to be processed, wherein the image correction comprises at least one of facial color correction processing, facial deformation correction processing, or facial makeup restoration processing.

In order to enable the trained target facial processing model to achieve the local processing of the facial images, and also reserve the initial facial information as much as possible to reduce the difference between the processed facial images and the initial facial images and improve the user experience, in this embodiment the method may further comprise, prior to training the target facial processing model: adjusting the facial processing sample image corresponding to the sample facial image to be processed required for training the target facial processing model, such that the facial processing sample image can comprise more features of the sample facial image to be processed, thereby making the processing effect of the trained target facial processing model more realistic.

In this embodiment, at least one of the facial color correction processing, the facial deformation correction processing, or the facial makeup restoration processing may be performed on the facial processing sample image corresponding to the sample facial image to be processed using the sample facial image to be processed. The facial color correction processing may be achieved by correcting the color of at least one area in the facial processing sample image to cause the color of at least one area in the corrected facial processing sample image to be close to the color of the same area in the sample facial image to be processed. The facial deformation correction processing may be achieved by correcting the shapes of the five facial features and/or a face angle in the facial processing sample image to cause the shapes of the five facial features and/or the face angle in the corrected facial processing sample image to be consistent with the shapes of the five facial features and/or the face angle in the sample facial image to be processed. The facial makeup restoration processing may be achieved by determining the makeup information in the facial processing sample image and adding the makeup information to the sample facial image to be processed corresponding to the facial processing sample image, so that the sample facial image to be processed is consistent with the makeup information in the facial processing sample image.

Exemplarily, when the image correction processing comprises the facial color correction processing, performing the image correction processing on the sample facial image to be processed or the facial processing sample image corresponding to the sample facial image to be processed may comprise: determining a facial skin area to be processed in the sample facial image to be processed, and determining a reference color mean value corresponding to a plurality of pixel points in the facial skin area to be processed; determining a facial skin area to be adjusted in the facial processing sample image corresponding to the sample facial image to be processed, and determining a color mean value to be adjusted corresponding to a plurality of pixel points in the facial skin area to be adjusted; and adjusting color values corresponding to the plurality of pixel points in the facial skin area to be adjusted according to the reference color mean value and the color mean value to be adjusted.

The facial skin area to be processed may be an area that requires the color correction, such as a cheek area, a forehead area, and a chin area. The cheek area, the forehead area, and the chin area may be segmented directly from the sample facial image to be processed according to a preset facial segmentation template, and these plurality of areas are determined as the facial skin areas to be processed. Alternatively, the segmentation of the facial skin areas to be processed may be obtained according to the five facial features in the sample facial image to be processed. For example, determining the facial skin area to be processed in the sample facial image to be processed may comprise: determining positions of the five facial features in the sample facial image to be processed; and segmenting the sample facial image to be processed according to the positions of the five facial features to obtain each facial skin area to be processed.

The reference color mean value corresponding to the plurality of pixel points in the facial skin area to be processed is determined. The reference color mean value may be a color mean value of the pixel points in areas in the facial skin area to be processed other than the five facial features, or the reference color mean value may be a color mean value of the pixel points in a central area in the facial skin area to be processed other than the five facial features. Meanwhile, an area in the facial processing sample image that corresponds to the facial skin area to be processed, i.e., the facial skin area to be adjusted, may also be determined, and the color mean value to be adjusted that corresponds to a plurality of pixel points in the facial skin area to be processed is determined. The color mean value to be adjusted may be a color mean value of the pixel points in areas in the facial skin area to be adjusted other than the five facial features, or the color mean value to be adjusted may be a color mean value of the pixel points in a central area in the facial skin area to be adjusted other than the five facial features.

Adjusting the color values corresponding to the plurality of pixel points in the facial skin area to be adjusted according to the reference color mean value and the color mean value to be adjusted may comprise: determining a color deviation corresponding to the color mean value to be adjusted relative to the reference color mean value; and adding the color deviation to a color value corresponding to each pixel point in the facial skin area to be adjusted to update the color value corresponding to each pixel point in the facial skin area to be adjusted. The color deviation may be calculated by determining a difference between the reference color mean value and the color mean value to be adjusted. The color deviation may be positive, that is, the color mean value to be adjusted is less than the reference color mean value. Alternatively, the color deviation may be negative, that is, the color mean value to be adjusted is greater than the reference color mean value.

In this example, the facial skin area to be processed in the sample facial image to be processed, the reference color mean value corresponding to the plurality of pixel points in the facial skin area to be processed, the facial skin area to be adjusted in the facial processing sample image, and the color mean value to be adjusted corresponding to the plurality of pixel points in the facial skin area to be adjusted are determined, and the color values corresponding to the plurality of pixel points in the facial skin area to be adjusted are adjusted using the reference color mean value and the color mean value to be adjusted. As such, the facial color correction processing performed on the facial processing sample image is achieved. Thus, the facial color in the facial processing sample image in the pair is closer to the facial color in the sample facial image to be processed in the pair, and the trained target facial processing model can maintain the initial facial color as much as possible when achieving the facial processing. This improves the user experience.

In another example, when the image correction processing comprises the facial makeup restoration processing, performing the image correction processing on the sample facial image to be processed or the facial processing sample image corresponding to the sample facial image to be processed may comprise: if a facial area in the facial processing sample image comprises the makeup information, performing the makeup processing on the sample facial image to be processed corresponding to the facial processing sample image according to the makeup information.

Whether the facial area in the facial processing sample image comprises the makeup information may be determined by: segmenting, from the sample facial image to be processed, a plurality of facial areas to be discriminated based on a preset facial makeup area segmentation template; segmenting, from the facial processing sample image, a plurality of facial areas to be compared; and determining whether the facial area to be discriminated comprises the makeup information based on a color mean value of the facial area to be compared and a color mean value of the facial area to be discriminated corresponding to the facial area to be compared. The facial makeup area segmentation may comprise a lip-associated area, a nose bridge-associated area, and an eye-associated area. Alternatively, whether the facial area to be discriminated comprises the makeup information may be determined based on the contour information of the facial area to be compared and the contour information of the facial area to be discriminated corresponding to the facial area to be compared. The facial makeup area segmentation template further comprises an eyebrow-associated area and an eye extension area.

After it is determined that the facial area in the facial processing sample image comprises the makeup information, a makeup information transfer strategy may be adopted to copy the makeup information into the sample facial image to be processed. Alternatively, a makeup position comprised in the makeup information and the operation information corresponding to the makeup position are analyzed, and the makeup processing is performed on the sample facial image to be processed based on the makeup position and the operation information corresponding to the makeup position.

In this example, the makeup processing may be performed on the sample facial image to be processed corresponding to the facial processing sample image using the makeup information in the facial area of the facial processing sample image, such that the makeup information in the sample facial image to be processed is consistent with the makeup information in the paired facial processing sample image. Thus the trained target facial processing model maintains the initial facial makeup as much as possible when achieving the facial processing. This improves the user experience.

In another example, when the image correction processing comprises the facial deformation correction processing, performing the image correction processing on the sample facial image to be processed or the facial processing sample image corresponding to the sample facial image to be processed may comprise: determining correction key points of facial areas respectively in the sample facial image to be processed and the facial processing sample image corresponding to the sample facial image to be processed; and adjusting a shape of the facial area in the facial processing sample image according to a position of the correction key point in the sample facial image to be processed and a position of the correction key point in the facial processing sample image.

The correction key points may be facial key points located in the sample facial image to be processed and the facial processing sample image. For example, contours of the five facial features and a facial contour of the sample facial image to be processed and contours of the five facial features and a facial contour of the facial processing sample image may be acquired. A plurality of correction key points may be determined from the contours of the five facial features and the facial contours. Alternatively, the correction key points may be determined from the sample facial image to be processed and the facial processing sample image based on an Active Shape Model (ASM), an Active Appearance Model (AAM), a Cascaded Pose Regression (CPR), and the like.

The number of the correction key points determined from the sample facial image to be processed and the number of the correction key points determined from the facial processing sample image should be consistent. The correction key points in the sample facial image to be processed may correspond to the correction key points in the facial processing sample image in a one-to-one manner.

Based on the position of a correction key point in the sample facial image to be processed, the position of a correction key point, corresponding to the correction key point, in the facial processing sample image may be adjusted, such that the shape of the facial area in the facial processing sample image may be adjusted to be similar to the shape of the facial area in the sample facial image to be processed. The shape of the facial area may comprise the shapes of the five facial features and the face angle.

In this example, the correction key points of the facial areas in the sample facial image to be processed and the paired facial processing sample image are respectively determined, and the shape of the facial area in the facial processing sample image is adjusted according to the positions of the correction key points. As such, the facial shape of the sample facial image to be processed and the facial shape of the corresponding facial processing sample image may be consistent with each other as much as possible, and thus the trained target facial processing model maintains the initial facial shape as much as possible when achieving the facial processing. This improves the user experience.

S450. Train an initial facial processing model according to the sample facial image to be processed and the facial processing sample image corresponding to the sample facial image to be processed to obtain the target facial processing model.

According to the technical solutions of this embodiment, prior to training the initial facial processing model according to the sample facial image to be processed and the facial processing sample image corresponding to the sample facial image to be processed, at least one of the facial color correction processing, the facial deformation correction processing, or the facial makeup restoration processing is performed on the sample facial image to be processed or the facial processing sample image corresponding to the sample facial image to be processed. This reduces a facial color difference, a facial deformation difference, or a facial makeup difference between the sample facial image to be processed and the facial processing sample image, thus the trained target facial processing model can output a processed image that maintains more initial facial information, and the user experience can be improved.

### Embodiment V

FIG. 5 is a flowchart of an image processing method according to Embodiment V of the present disclosure. In this embodiment, based on any technical solution of the embodiments of the present disclosure, the method further comprises after obtaining the facial processing target image with the target facial effect: displaying the facial processing target image in a target display area. As shown in FIG. 5, the image processing method provided in this embodiment comprises the following steps:

S510. Acquire a target facial image to be processed of a target object, and input the target facial image to be processed to a pre-trained target facial processing model to obtain a facial processing target image with a target facial effect.

S520. Display the facial processing target image in a target display area.

The target display area may be a preset area used for displaying the facial processing target image. Exemplarily, the target display area may be the entire area of a display interface. Alternatively, the target display area may be a local area of a display interface.

The display interface may be divided into two local areas, such as, two local areas having the same sizes and located at a top and bottom of the display interface; or, two local areas having the same sizes and located on left and right sides of the display interface; or, two independent areas having different sizes and located at different positions in the display interface.

The advantage of setting the local area as the target display area in the display interface is that, it is convenient to display both the facial processing target image and the target facial image to be processed simultaneously, such that a user can compare the facial processing target image with the target facial image to be processed, that is, compare the facial images before and after the processing. This improves the user experience.

In this embodiment, the facial processing target image may be directly displayed in the target display area. The facial processing target images in different processing degrees may also be directly displayed in the target display area. Alternatively, a facial processing target image with a processing degree corresponding to an user operation may be displayed according to the user operation.

That is, the method further comprises, after obtaining the facial processing target image with the target facial effect: displaying an effect adjustment control for adjusting an image processing degree in the target display area; and when a processing degree adjustment operation performed on the effect adjustment control is received, displaying the facial processing target image corresponding to the processing degree adjustment operation in the target display area.

The effect adjustment control may exist in the form of a plurality of choice boxes or in the form of a progress bar. The user may select a processing degree by triggering a choice box in the effect adjustment control or by dragging the progress bar in the effect adjustment control.

After the processing degree adjustment operation performed by the user on the effect adjustment control is acquired, that is, the selected choice box or the position to which the progress bar is dragged is acquired, the facial processing target image corresponding to the processing degree adjustment operation may be displayed in the target display area. Different processing degree adjustment operations correspond to different degrees of the target facial effect in the facial processing target image. For example, the processing degree may be determined according to the processing degree adjustment operation, and the facial processing target image corresponding to the processing degree adjustment operation may be determined based on the processing degree.

In this implementation, the effect adjustment control used for adjusting the image processing degree is displayed; and after the processing degree adjustment operation performed on the effect adjustment control is received, the facial processing target image corresponding to the processing degree adjustment operation is displayed. This achieves the displaying of the facial processing target images with different processing degrees, and enables the user to select the processing degree, improves the diversity of the processed images, and greatly improves the user experience.

In an implementation, displaying the facial processing target image corresponding to the processing degree adjustment operation in the target display may comprise: determining a target weight corresponding to the processing degree adjustment operation; determining the facial processing target image corresponding to the processing degree adjustment operation according to the target facial image to be processed, the facial processing target image, the target weight, and a preset facial mask image; and displaying the adjusted facial processing target image in the target display area.

A pixel value of a facial skin area in the preset facial mask image is 1, and a pixel value of areas other than the facial skin area is 0. A range [0, 255] of a pixel value may be mapped to a range [0,1], where 0 represents the black color and 1 represents the white color. That is, the facial skin area in the preset facial mask image may be white, and the area other than the facial skin area, such as areas of the five facial features, may be black.

With the preset facial mask image, it is possible to adjust the processing degree of the facial skin area only, which avoids the adjustment performed on the processing degrees of the areas other than the facial skin area. The facial skin area in the facial processing target image and the facial skin area in the target facial image to be processed may be determined using the preset facial mask image. The pixel values of the facial skin areas in both the facial processing target image and the target facial image to be processed may be weighted using the target weight to obtain the facial processing target image corresponding to the processing degree adjustment operation.

In the process of weighting the pixel values of the facial skin areas in both the facial processing target image and the target facial image to be processed using the target weight, if the processing degree is smaller, the weight calculation value of the pixel values of the facial skin area in the target facial image to be processed is larger; and if the processing degree is larger, the weight calculation value of the pixel values of the facial skin area in the facial processing target image is larger.

In this implementation, the facial processing target image corresponding to the processing degree adjustment operation is determined according to the preset facial mask image, the target weight corresponding to the processing degree adjustment operation, the target facial image to be processed, and the facial processing target image. Thus the adjustment of the processing degree for the facial skin area is achieved, and the adjustment of the areas other than the facial skin area is avoided, thereby avoiding the distortions of the areas other than the facial skin area, and the user experience is improved.

In the above process, determining the facial processing target image corresponding to the processing degree adjustment operation according to the target facial image to be processed, the facial processing target image, the target weight, and a preset facial mask image may further comprise: weighting pixel values of a plurality of pixel points in the preset facial mask image according to the target weight to obtain a target adjustment weight corresponding to each pixel point; and for each pixel point to be adjusted in a facial area of the facial processing target image, calculating a target pixel value of the pixel to be adjusted according to an original pixel value of the pixel point to be adjusted in the target facial image to be processed, a current pixel value of the pixel point to be adjusted in the facial processing target image, and the target adjustment weight corresponding to the pixel to be adjusted, so as to obtain the facial processing target image corresponding to the processing degree adjustment operation.

That is, the pixel values in the preset facial mask image may also be weighted using the target weight to obtain the target adjustment weights for the various pixel points. For each pixel point to be adjusted in the facial area of the facial processing target image, the weighting may be performed according to the original pixel value of the pixel point to be adjusted in the target facial image to be processed, the current pixel value of the pixel point to be adjusted in the facial processing target image, and the target adjustment weight corresponding to the pixel to be adjusted, to obtain the target pixel value of the pixel point to be adjusted. In this way, this achieves adjusting the processing degree of each pixel point to be adjusted in the facial area of the facial processing target image to obtain the facial processing target image corresponding to the processing degree adjustment operation.

Exemplarily, the above implementation may be represented by the following formula:

$$output = a \times ( 1 - t \times mask ) + b \times ( t \times mask )$$

wherein the output represents the facial processing target image corresponding to the processing degree adjustment operation; a represents the original pixel value of the pixel point to be adjusted in the target facial image to be processed; b represents the current pixel value of the pixel point to be adjusted in the facial processing target image; t represents the target weight corresponding to the processing degree adjustment operation; and tx mask represents the target adjustment weight corresponding to the pixel point to be adjusted.

In this implementation, the target adjustment weight corresponding to each pixel point may be obtained using the target weight and the preset facial mask image, such that for each pixel point to be adjusted in the facial area in the facial processing target image, the target pixel value is calculated according to the target adjustment weight corresponding to the pixel point to be adjusted, the original pixel value of the pixel point to be adjusted in the target facial image to be processed, and the current pixel value of the pixel point to be adjusted in the facial processing target image. This achieves the adjustment of the pixel values of the facial processing target image based on the processing degree adjustment operation, and thus achieves the accurate adjustment of the processing degree of the facial processing target image and improves the user experience.

According to the technical solutions of this embodiment, the target facial image to be processed of the target object is acquired, and the target facial image to be processed is input to the pre-trained target facial processing model to obtain the facial processing target image with the target facial effect; and the facial processing target image is displayed in the target display area. This achieves interactions with the user. It is convenient for the user to view the processed facial image, and thus the user experience is improved.

### Embodiment VI

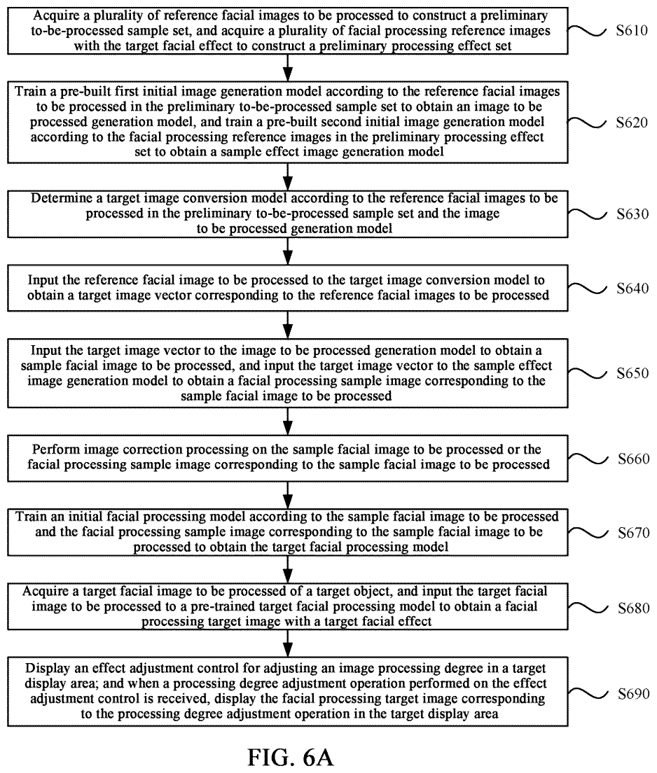

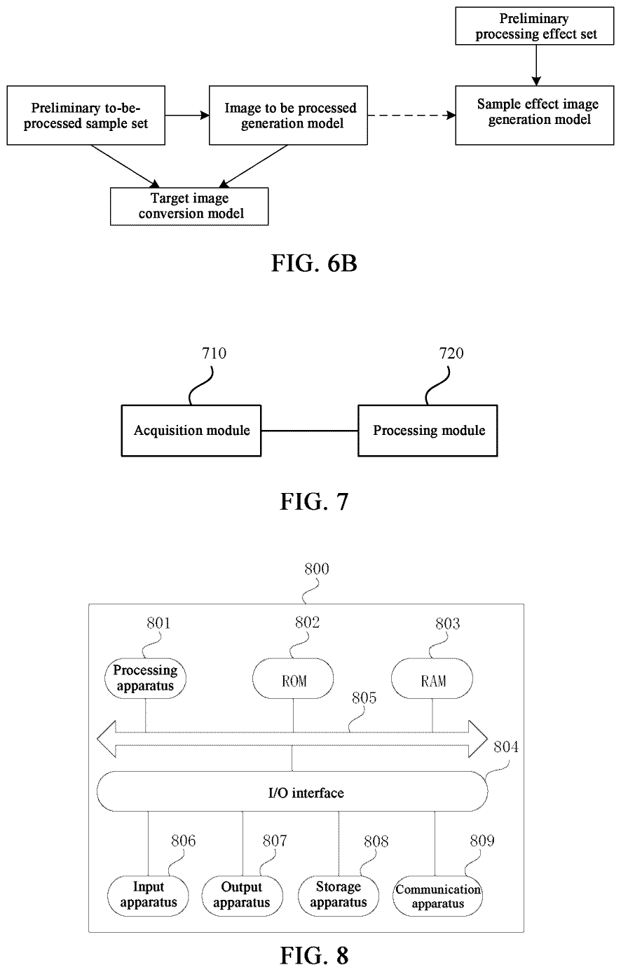

FIG. 6A shows a flowchart of an image processing method according to Embodiment VI of the present disclosure. As shown in FIG. 6A, the method comprises the following steps:

S610. Acquire a plurality of reference facial images to be processed to construct a preliminary to-be-processed sample set, and acquire a plurality of facial processing reference images with the target facial effect are acquired to construct a preliminary processing effect set.

S620. Train a pre-built first initial image generation model according to the reference facial images to be processed in the preliminary to-be-processed sample set to obtain an image to be processed generation model, and train a pre-built second initial image generation model according to the facial processing reference images in the preliminary processing effect set to obtain a sample effect image generation model.

S630. Determine a target image conversion model according to the reference facial images to be processed in the preliminary to-be-processed sample set and the image to be processed generation model.

Exemplarily, FIG. 6B shows a schematic diagram of the model training based on a preliminary to-be-processed sample set and a preliminary processing effect set. Firstly, the image to be processed generation model is trained using the preliminary to-be-processed sample set, and the sample effect image generation model is trained using the preliminary processing effect set. Then, the target image conversion model is trained using the image to be processed generation model and the preliminary to-be-processed sample set.

S640. Input the reference facial image to be processed to the target image conversion model to obtain a target image vector corresponding to the reference facial image to be processed.

S650. Input the target image vector to the image to be processed generation model to obtain a sample facial image to be processed, and input the target image vectors to the sample effect image generation model to obtain a facial processing sample image corresponding to the sample facial image to be processed.

S660. Perform image correction processing on the sample facial image to be processed or the facial processing sample image corresponding to the sample facial image to be processed.

S670. Train an initial facial processing model according to the sample facial image to be processed and the facial processing sample image corresponding to the sample facial image to be processed to obtain the target facial processing model.

S680. Acquire a target facial image to be processed of a target object, and input the target facial image to be processed to a pre-trained target facial processing model to obtain a facial processing target image with a target facial effect.

S690. Display an effect adjustment control for adjusting an image processing degree in a target display area; and when a processing degree adjustment operation performed on the effect adjustment control is received, display the facial processing target image corresponding to the processing degree adjustment operation in the target display area.

According to the technical solutions of this embodiment, a large number of paired sample facial images to be processed and facial processing sample images are determined, which provides a data support for the training of the target facial processing model, ensures the output accuracy of the target facial processing model, enables the target facial processing model to automatically perform fine processing on a plurality of local areas in a facial image, improves the processing effect on the facial image, and reduces the complication of processing the facial image without manual adjustment by a user. The target facial processing model can also maintain more original facial image information while processing local areas, such that the user experience is improved.

### Embodiment VII

FIG. 7 shows a schematic structural diagram of an image processing apparatus according to Embodiment VII of the present disclosure. The image processing apparatus provided in this embodiment may be implemented by software and/or hardware, and may be configured in a terminal and/or a server to implement the image processing method in the embodiments of the present disclosure. The apparatus may comprise:

an acquisition module 710, configured for acquiring a target facial image to be processed of a target object; and a processing module 720, configured for inputting the target facial image to be processed to a pre-trained target facial processing model to obtain a facial processing target image with a target facial effect. The target facial processing model is trained by: acquiring a plurality of reference facial images to be processed to construct a preliminary to-be-processed sample set, and acquiring a plurality of facial processing reference images with the target facial effect to construct a preliminary processing effect set; determining a sample facial image to be processed and a facial processing sample image corresponding to the sample facial images to be processed according to the reference facial images to be processed in the preliminary to-be-processed sample set and the facial processing reference images in the preliminary processing effect set; and training an initial facial processing model according to the sample facial image to be processed and the facial processing sample image corresponding to the sample facial image to be processed to obtain the target facial processing model.

Based on any technical solution in the embodiments of the present disclosure, the apparatus further comprises a first model training module, a second model training module, and an image pairing module. The first model training module is configured for training a pre-built first initial image generation model according to the reference facial images to be processed in the preliminary to-be-processed sample set to obtain an image to be processed generation model; the second model training module is configured for training a pre-built second initial image generation model according to the facial processing reference images in the preliminary processing effect set to obtain a sample effect image generation model; and the image pairing module is configured for generating the sample facial image to be processed and the facial processing sample image corresponding to the sample facial image to be processed according to the image to be processed generation model and the sample effect image generation model, wherein the first initial image generation model and the second initial image generation model are style-based generative adversarial networks.

Based on any technical solution in the embodiments of the present disclosure, the image pairing module comprises a conversion model training unit and an image generation unit. The conversion model training unit is configured for determining a target image conversion model according to the reference facial images to be processed in the preliminary to-be-processed sample set and the image to be processed generation model, wherein the target image conversion model is used for converting an image input to the target image conversion model into a target image vector; and the image generation unit is configured for generating the sample facial image to be processed according to the image to be processed generation model, and generating the facial processing sample image corresponding to the sample facial image to be processed according to the sample facial image to be processed, the target image conversion model, and the sample effect image generation model.

Based on any technical solution in the embodiments of the present disclosure, the conversion model training unit is configured for:
inputting the reference facial images to be processed in the preliminary to-be-processed sample set to an initial image conversion model to obtain model conversion vectors; inputting the model conversion vectors to the image to be processed generation model to obtain model-generated images corresponding to the model conversion vectors; and performing parameter adjustment on the initial image conversion model according to a loss between the model-generated images and the reference facial images to be processed that are input to the initial image conversion model and correspond to the model-generated images, so as to obtain the target image conversion model.

Based on any technical solution in the embodiments of the present disclosure, the image generation unit is configured for:
inputting the reference facial images to be processed to the target image conversion model to obtain target image vectors corresponding to the reference facial images to be processed; inputting the target image vectors to the image to be processed generation model to obtain the sample facial image to be processed; and inputting the target image vectors to the sample effect image generation model to obtain the facial processing sample image corresponding to the sample facial image to be processed.

Based on any technical solution in the embodiments of the present disclosure, the apparatus further comprises a training preprocessing module. The training preprocessing module is configured for: prior to training an initial facial processing model according to the sample facial image to be processed and the facial processing sample image corresponding to the sample facial image to be processed, performing image correction processing on the sample facial image to be processed or the facial processing sample image corresponding to the sample facial image to be processed, wherein the image correction comprises at least one of facial color correction processing, facial deformation correction processing, and facial makeup restoration processing.

Based on any technical solution in the embodiments of the present disclosure, the training preprocessing module comprises a color correction unit; the color correction unit is configured for: when the image correction processing comprises the facial color correction processing, determining a facial skin area to be processed in the sample facial image to be processed, and determining a reference color mean value corresponding to a plurality of pixel points in the facial skin area to be processed; determining a facial skin area to be adjusted in the facial processing sample image corresponding to the sample facial image to be processed, and determining a color mean value to be adjusted corresponding to a plurality of pixel points in the facial skin area to be adjusted; and adjusting color values corresponding to the plurality of pixel points in the facial skin area to be adjusted according to the reference color mean value and the color mean value to be adjusted.

Based on any technical solution in the embodiments of the present disclosure, the training preprocessing module comprises a makeup restoration unit. The makeup restoration unit is configured for: when the image correction processing comprises the facial makeup restoration processing, if a facial area in the facial processing sample image comprises makeup information, performing makeup processing on the sample facial image to be processed corresponding to the facial processing sample image according to the makeup information.

Based on any technical solution in the embodiments of the present disclosure, the training preprocessing module comprises a deformation correction unit. The deformation correction unit is configured for: when the image correction processing comprises the facial deformation correction processing, respectively determining correction key points of facial areas in the sample facial image to be processed and the facial processing sample image corresponding to the sample facial image to be processed; and adjusting a shape of the facial area in the facial processing sample image according to a position of the correction key point in the sample facial image to be processed and a position of the correction key point in the facial processing sample image.

Based on any technical solution in the embodiments of the present disclosure, the initial facial processing model comprises a processing effect generation model and a processing effect discrimination module. The apparatus further comprises a target model training module. The target model training module comprises an effect generation unit, a first adjustment unit, and a second adjustment unit. The effect generation unit is configured for: inputting the sample facial image to be processed to the processing effect generation model to obtain a processing effect generation image; the first adjustment unit is configured for adjusting the processing effect generation model according to the sample facial image to be processed, the processing effect generation image, and the facial processing sample image corresponding to the sample facial image to be processed; and the second adjustment unit is configured for determining, according to a discrimination result obtained by the processing effect discrimination model for the processing effect generation image, whether to stop adjusting the processing effect generation model, and using the processing effect generation model obtained at the end of the adjustment as the target facial processing model.

Based on any technical solution in the embodiments of the present disclosure, the first adjustment unit is configured for:
determining a first facial feature loss between the sample facial image to be processed and the processing effect generation image, and determining a second facial feature loss between the processing effect generation image and the facial processing sample image corresponding to the sample facial image to be processed; and adjusting the processing effect generation model according to the first facial feature loss and the second facial feature loss.

Based on any technical solution in the embodiments of the present disclosure, the acquisition module 710 is configured for:
in response to a received processing trigger operation used for generating the facial processing target image with the target facial effect, capturing the target facial image to be processed of the target object based on an image capturing device, or receiving the target facial image to be processed of the target object based on an image upload control.

Based on any technical solution in the embodiments of the present disclosure, the apparatus further comprises an image display module. The image display module is configured for displaying the facial processing target image in a target display area.

Based on any technical solution in the embodiments of the present disclosure, the image display module comprises a control display unit and an effect adjustment unit. The control display unit is configured for displaying an effect adjustment control used for adjusting an image processing degree in the target display area; and the effect adjustment unit is configured for: when a processing degree adjustment operation performed on the effect adjustment control is received, displaying the facial processing target image corresponding to the processing degree adjustment operation in the target display area.

Based on any technical solution in the embodiments of the present disclosure, the effect adjustment unit comprises an effect display subunit. The effect display subunit is configured for: determining a target weight corresponding to the processing degree adjustment operation, determining the facial processing target image corresponding to the processing degree adjustment operation according to the target facial image to be processed, the facial processing target image, the target weight, and a preset facial mask image, and displaying the adjusted facial processing target image in the target display area, wherein a pixel value of a facial skin area in the preset facial mask image is 1, and a pixel value of an area other than the facial skin area is 0.

Based on any technical solution in the embodiments of the present disclosure, the effect display subunit is configured for:
determining a target weight corresponding to the processing degree adjustment operation, and weighting pixel values of a plurality of pixel points in the preset facial mask image according to the target weight to obtain a target adjustment weight corresponding to each of the pixel points; for each pixel point to be adjusted in a facial area of the facial processing target image, calculating a target pixel value of the pixel to be adjusted according to an original pixel value of the pixel point to be adjusted in the facial processing target image, a current pixel value of the pixel point to be adjusted in the facial processing target image, and the target adjustment weight corresponding to the pixel to be adjusted, so as to obtain the facial processing target image corresponding to the processing degree adjustment operation; and displaying the adjusted facial processing target image in the target display area.

The above image processing apparatus may implement the image processing method provided in any embodiment of the present disclosure, and has corresponding functional modules for implementing the method and corresponding beneficial effects.

The multiple units and modules comprised in the above apparatus are only divided according to a functional logic, but are not limited to the above division, as long as the corresponding functions may be achieved. In addition, the names of the multiple functional units are only for the purpose of distinguishing and are not used to limit the protection scope of the embodiments of the present disclosure.

### Embodiment VIII

FIG. 8 shows a schematic structural diagram of an electronic device according to Embodiment VIII of the present disclosure. Reference is now made to FIG. 8 below, which illustrates a schematic structural diagram of an electronic device (namely, a terminal device or a server in FIG. 8) 800 suitable for implementing an embodiments of the present disclosure. The terminal device in the embodiments of the present disclosure may comprise, but are not limited to, a mobile phone, a laptop, a digital broadcast receiver, a Personal Digital Assistant (PDA), a Portable Android Device (PAD), a Portable Media Player (PMP), a mobile terminal such as a vehicle-mounted terminal (for example, a vehicle-mounted navigation terminal), and a fixed terminal such as digital television (TV) and a desktop computer. The electronic device 800 shown in FIG. 8 is only an example and should not impose any limitations on the functionality and scope of use of the embodiments of the present disclosure.

As shown in FIG. 8, the electronic device 800 may comprise a processing apparatus (such as a central processing unit and graphics processor) 801 that may perform various appropriate actions and processing according to programs stored in a Read-Only Memory (ROM) 802 or loaded from a storage apparatus 808 to a Random Access Memory (RAM) 803. Various programs and data required for operations of the electronic device 800 may also be stored in the RAM 803. The processing apparatus 801, the ROM 802, and the RAM 803 are connected to each other through a bus 805. An Input/Output (I/O) interface 804 is also connected to the bus 805.

Usually, following apparatuses may be connected to the I/O interface 804: an input apparatus 806 comprising a touch screen, a touchpad, a keyboard, a mouse, a camera, a microphone, an accelerometer, a gyroscope, and the like; an output apparatus 807 comprising a Liquid Crystal Display (LCD), a speaker, a vibrator, and the like; a storage apparatus 808 comprising a magnetic tape, a hard disk drive, and the like; and a communication apparatus 809. The communication apparatus 809 may allow the electronic device 800 to wirelessly or wiredly communicate with other devices to exchange data. Although FIG. 8 shows the electronic device 800 with various apparatuses, the electronic device 800 is not required to implement or have all the apparatuses shown, and may alternatively implement or have more or fewer apparatuses.

According to the embodiments of the present disclosure, the process described in the reference flowchart above may be implemented as a computer software program. For example, the embodiments of the present disclosure comprise a computer program product, comprising a computer program carried on a non-transitory computer-readable medium, and the computer program comprises program codes used for performing the methods shown in the flowcharts. In such an embodiment, the computer program may be downloaded and installed from a network through the communication apparatus 809, or installed from the storage apparatus 808, or installed from the ROM 802. When the computer program is executed by the processing apparatus 801, the above-mentioned functions defined in the methods of the embodiments of the present disclosure are executed.

Messages or names of information exchanged between a plurality of apparatuses in the implementations of the present disclosure are only for illustrative purposes and are not intended to limit the messages or the scope of the information.

The electronic device provided according to the embodiments of the present disclosure and the image processing method provided in the above embodiments belong to the same concept. Technical details not fully described in this embodiment may be found in the above embodiments, and this embodiment has the same effects as the above embodiments.

### Embodiment IX

The embodiments of the present disclosure provide a computer storage medium for storing a computer program. Execution of the program by a processor implements the image processing method provided in the above embodiments.

The computer-readable medium mentioned in the present disclosure may be a computer-readable signal medium, a computer-readable storage medium, or any combination of the computer-readable signal medium and the computer-readable storage medium. The computer-readable storage medium may be, for example, but not limited to, electric, magnetic, optical, electromagnetic, infrared, or semiconductor systems, apparatuses, or devices, or any combination of the above. Examples of the computer-readable storage medium may comprise but are not limited to: an electrical connection with one or more wires, a portable computer disk, a hard disk drive, a Random Access Memory (RAM), a Read-Only Memory (ROM), an Erasable Programmable Read Only Memory (EPROM) or flash memory, an optical fiber, a Compact Disc Read-Only Memory (CD-ROM), an optical storage device, a magnetic storage device, or any suitable combination of the above. In the present disclosure, the computer-readable storage medium may be any tangible medium that contains or stores a program, and the program may be used by or in combination with an instruction execution system, apparatus, or device. In the present disclosure, the computer-readable signal media may comprise data signals propagated in a baseband or as part of a carrier wave, which carries computer-readable program codes. The propagated data signals may be in various forms, comprising but not limited to: electromagnetic signals, optical signals, or any suitable combination of the above. The computer-readable signal medium may also be any computer-readable medium other than a computer-readable storage medium. The computer-readable signal medium may send, propagate, or transmit programs for use by or in combination with an instruction execution system, apparatus, or device. The program codes contained in the computer-readable medium may be transmitted using any suitable medium, comprising but not limited to: a wire, an optical cable, a Radio Frequency (RF), and the like, or any suitable combination of the above.

In some implementations, clients and servers may communicate using any currently known or future developed network protocol such as a HyperText Transfer Protocol (HTTP), and may intercommunicate and be interconnected with digital data in any form or medium (for example, a communication network). Examples of the communication network comprise a Local Area Network (LAN), a Wide Area Network (WAN), an internet (such as an Internet), a point-to-point network (such as an ad hoc point-to-point network, and any currently known or future developed network.

The computer-readable medium may be comprised in the electronic device or exist alone and is not assembled into the electronic device.

The above computer-readable medium carries one or more programs. Execution of the one or more programs by the electronic device causes the electronic device to:
acquire a target facial image to be processed of a target object; and input the target facial image to be processed to a pre-trained target facial processing model to obtain a facial processing target image with a target facial effect, wherein the target facial processing model is trained by: acquiring a plurality of reference facial images to be processed to construct a preliminary to-be-processed sample set, and acquiring a plurality of facial processing reference images with the target facial effect to construct a preliminary processing effect set; determining a sample facial image to be processed and a facial processing sample image corresponding to the sample facial images to be processed according to the reference facial images to be processed in the preliminary to-be-processed sample set and the facial processing reference images in the preliminary processing effect set; and training an initial facial processing model according to the sample facial image to be processed and the facial processing sample image corresponding to the sample facial image to be processed to obtain the target facial processing model.

Computer program codes for performing the operations of the present disclosure may be written in one or more programming languages or a combination thereof. The above programming languages comprise but are not limited to an object-oriented programming language such as Java, Smalltalk, and C++, and conventional procedural programming languages such as “C” language or similar programming languages. The program codes may be executed entirely on a user computer, partly on a user computer, as a stand-alone software package, partly on a user computer and partly on a remote computer, or entirely on a remote computer or a server. In a case where a remote computer is involved, the remote computer may be connected to a user computer through any kind of networks, comprising a LAN or a WAN, or may be connected to an external computer (for example, through an Internet using an Internet service provider).

The flowcharts and block diagrams in the accompanying drawings illustrate possible system architectures, functions, and operations that may be implemented by a system, a method, and a computer program product according to various embodiments of the present disclosure. In this regard, each block in a flowchart or a block diagram may represent a module, a program, or a part of a code. The module, the program, or the part of the code comprises one or more executable instructions used for implementing specified logic functions. In some implementations used as substitutes, functions annotated in blocks may alternatively occur in a sequence different from that annotated in an accompanying drawing. For example, actually two blocks shown in succession may be performed basically in parallel, and sometimes the two blocks may be performed in a reverse sequence. This is determined by a related function. It is also noted that each box in a block diagram and/or a flowchart and a combination of boxes in the block diagram and/or the flowchart may be implemented by using a dedicated hardware-based system configured to perform a specified function or operation, or may be implemented by using a combination of dedicated hardware and a computer instruction.

The units described in the embodiments of the present disclosure may be implemented through software or hardware. The name of the unit does not constitute a limitation on the unit itself. For example, the first obtaining unit may also be described as “a unit that obtains at least two Internet protocol addresses”.

The functions described herein above may be performed, at least in part, by one or a plurality of hardware logic components. For example, demonstration types of hardware logic components that may be used comprise, without any limitation: a Field Programmable Gate Array (FPGA), an Application Specific Integrated Circuit (ASIC), an Application Specific Standard Part (ASSP), a System on Chip (SOC), a Complex Programmable Logic Device (CPLD), and the like.

In the context of the present disclosure, a machine-readable medium may be a tangible medium that may comprise or store a program for use by an instruction execution system, apparatus, or device or in connection with the instruction execution system, apparatus, or device. The machine-readable medium may be a machine-readable signal medium or a machine-readable storage medium. The machine-readable medium may comprise, but is not limited to, an electronic, magnetic, optical, electromagnetic, infrared, or semiconductor system, apparatus, or device, or any suitable combination of the above content. Examples of the machine-readable storage medium may comprise an electrical connection based on one or more wires, a portable computer disk, a hard disk drive, a RAM, a ROM, an EPROM or flash memory, an optical fiber, a CD-ROM, an optical storage device, a magnetic storage device, or any suitable combinations of the above contents.

According to one or more embodiments of the present disclosure, [Example I] provides an image processing method. The method comprises:
acquiring a target facial image to be processed of a target object; and
inputting the target facial image to be processed to a pre-trained target facial processing model to obtain a facial processing target image with a target facial effect,
wherein the target facial processing model is trained by:
acquiring a plurality of reference facial images to be processed to construct a preliminary to-be-processed sample set, and acquiring a plurality of facial processing reference images with the target facial effect to construct a preliminary processing effect set;
determining a sample facial image to be processed and a facial processing sample image corresponding to the sample facial image to be processed according to the reference facial images to be processed in the preliminary to-be-processed sample set and the facial processing reference images in the preliminary processing effect set; and
training an initial facial processing model according to the sample facial image to be processed and the facial processing sample image corresponding to the sample facial image to be processed to obtain the target facial processing model.

According to one or more embodiments of the present disclosure, [Example II] provides an image processing method. The method further comprises:
the determining a sample facial image to be processed and a facial processing sample image corresponding to the sample facial image to be processed according to the reference facial images to be processed in the preliminary to-be-processed sample set and the facial processing reference images in the preliminary processing effect set comprises:
training a pre-built first initial image generation model according to the reference facial images to be processed in the preliminary to-be-processed sample set to obtain an image to be processed generation model;
training a pre-built second initial image generation model according to the facial processing reference images in the preliminary processing effect set to obtain a sample effect image generation model; and
generating the sample facial image to be processed and the facial processing sample image corresponding to the sample facial image to be processed according to the image to be processed generation model and the sample effect image generation model,
wherein the first initial image generation model and the second initial image generation model are style-based generative adversarial networks.

According to one or more embodiments of the present disclosure, [Example III] provides an image processing method. The method further comprises:
the generating the sample facial image to be processed and the facial processing sample image corresponding to the sample facial image to be processed according to the image to be processed generation model and the sample effect image generation model comprises:
determining a target image conversion model according to the reference facial images to be processed in the preliminary to-be-processed sample set and the image to be processed generation model, wherein the target image conversion model is used for converting an image input to the target image conversion model into a target image vector; and
generating the sample facial image to be processed according to the image to be processed generation model, and generating the facial processing sample image corresponding to the sample facial image to be processed according to the sample facial image to be processed, the target image conversion model, and the sample effect image generation model.

According to one or more embodiments of the present disclosure, [Example IV] provides an image processing method. The method further comprises:
determining a target image conversion model according to the reference facial images to be processed in the preliminary to-be-processed sample set and the image to be processed generation model comprises:
inputting the reference facial images to be processed in the preliminary to-be-processed sample set to an initial image conversion model to obtain model conversion vectors;
inputting the model conversion vectors to the image to be processed generation model to obtain model-generated images corresponding to the model conversion vectors; and
performing parameter adjustment on the initial image conversion model according to a loss between the model-generated images and the reference facial images to be processed that are input to the initial image conversion model and correspond to the model-generated images, so as to obtain the target image conversion model.

According to one or more embodiments of the present disclosure, [Example V] provides an image processing method. The method further comprises:
generating the sample facial image to be processed according to the image to be processed generation model, and generating the facial processing sample image corresponding to the sample facial image to be processed according to the sample facial image to be processed, the target image conversion model, and the sample effect image generation model comprises:
inputting the reference facial images to be processed to the target image conversion model to obtain target image vectors corresponding to the reference facial images to be processed;
inputting the target image vectors to the image to be processed generation model to obtain the sample facial image to be processed; and
inputting the target image vectors to the sample effect image generation model to obtain the facial processing sample image corresponding to the sample facial image to be processed.

According to one or more embodiments of the present disclosure, [Example VI] provides an image processing method. The method further comprises:
prior to training an initial facial processing model according to the sample facial image to be processed and the facial processing sample image corresponding to the sample facial image to be processed, the method further comprises:
performing image correction processing on the sample facial image to be processed or the facial processing sample image corresponding to the sample facial image to be processed, wherein the image correction comprises at least one of facial color correction processing, facial deformation correction processing, and facial makeup restoration processing.

According to one or more embodiments of the present disclosure, [Example VII] provides an image processing method. The method further comprises:
in an event that the image correction processing comprises the facial color correction processing, the performing image correction processing on the sample facial image to be processed or the facial processing sample image corresponding to the sample facial image to be processed comprises:
determining a facial skin area to be processed in the sample facial image to be processed, and determining a reference color mean value corresponding to a plurality of pixel points in the facial skin area to be processed;
determining a facial skin area to be adjusted in the facial processing sample image corresponding to the sample facial image to be processed, and determining a color mean value to be adjusted corresponding to a plurality of pixel points in the facial skin area to be adjusted; and
adjusting color values corresponding to the plurality of pixel points in the facial skin area to be adjusted according to the reference color mean value and the color mean value to be adjusted.

According to one or more embodiments of the present disclosure, [Example VIII] provides an image processing method. The method further comprises:
in an event that the image correction processing comprises the facial makeup restoration processing, the performing image correction processing on the sample facial image to be processed or the facial processing sample image corresponding to the sample facial image to be processed comprises:
in an event that a facial area in the facial processing sample image comprises makeup information, performing makeup processing on the sample facial image to be processed corresponding to the facial processing sample image according to the makeup information.

According to one or more embodiments of the present disclosure, [Example IX] provides an image processing method. The method further comprises:
in an event that the image correction processing comprises the facial deformation correction processing, the performing image correction processing on the sample facial image to be processed or the facial processing sample image corresponding to the sample facial image to be processed comprises:
respectively determining correction key points of facial areas in the sample facial image to be processed and the facial processing sample image corresponding to the sample facial image to be processed; and
adjusting a shape of the facial area in the facial processing sample image according to a position of the correction key point in the sample facial image to be processed and a position of the correction key point in the facial processing sample image.

According to one or more embodiments of the present disclosure, [Example X] provides an image processing method. The method further comprises:
the initial facial processing model comprises a processing effect generation model and a processing effect discrimination model; and the training an initial facial processing model according to the sample facial image to be processed and the facial processing sample image corresponding to the sample facial image to be processed to obtain the target facial processing model comprises:
inputting the sample facial image to be processed to the processing effect generation model to obtain a processing effect generation image;
adjusting the processing effect generation model according to the sample facial image to be processed, the processing effect generation image, and the facial processing sample image corresponding to the sample facial image to be processed; and
determining, according to a discrimination result obtained by the processing effect discrimination model for the processing effect generation image, whether to stop adjusting the processing effect generation model, and using the processing effect generation model obtained at the end of the adjustment as the target facial processing model.

According to one or more embodiments of the present disclosure, [Example XI] provides an image processing method. The method further comprises:
the adjusting the processing effect generation model according to the sample facial image to be processed, the processing effect generation image, and the facial processing sample image corresponding to the sample facial image to be processed comprises:
determining a first facial feature loss between the sample facial image to be processed and the processing effect generation image, and determining a second facial feature loss between the processing effect generation image and the facial processing sample image corresponding to the sample facial image to be processed; and
adjusting the processing effect generation model according to the first facial feature loss and the second facial feature loss.

According to one or more embodiments of the present disclosure, [Example XII] provides an image processing method. The method further comprises:
acquiring a target facial image to be processed of a target object comprises:
in response to a received processing trigger operation used for generating the facial processing target image with the target facial effect, capturing the target facial image to be processed of the target object based on an image capturing device, or receiving the target facial image to be processed of the target object based on an image upload control.

According to one or more embodiments of the present disclosure, [Example XIII] provides an image processing method. The method further comprises:
after obtaining a facial processing target image with a target facial effect, the method further comprises:
displaying the facial processing target image in a target display area.

According to one or more embodiments of the present disclosure, [Example XIV] provides an image processing method. The method further comprises:
after obtaining a facial processing target image with a target facial effect, the method further comprises:
displaying an effect adjustment control used for adjusting an image processing degree in the target display area; and
when a processing degree adjustment operation performed on the effect adjustment control is received, displaying the facial processing target image corresponding to the processing degree adjustment operation in the target display area.

According to one or more embodiments of the present disclosure, [Example XV] provides an image processing method. The method further comprises:
displaying the facial processing target image corresponding to the processing degree adjustment operation in the target display area comprises:
determining a target weight corresponding to the processing degree adjustment operation, determining the facial processing target image corresponding to the processing degree adjustment operation according to the target facial image to be processed, the facial processing target image, the target weight, and a preset facial mask image, and displaying the adjusted facial processing target image in the target display area, wherein a pixel value of a facial skin area in the preset facial mask image is 1, and a pixel value of an area other than the facial skin area is 0.

According to one or more embodiments of the present disclosure, [Example XVI] provides an image processing method. The method further comprises:
determining the facial processing target image corresponding to the processing degree adjustment operation according to the target facial image to be processed, the facial processing target image, the target weight, and a preset facial mask image comprises:
weighting pixel values of a plurality of pixel points in the preset facial mask image according to the target weight to obtain a target adjustment weight corresponding to each of the pixel points; and
for each pixel point to be adjusted in a facial area of the facial processing target image, calculating a target pixel value of the pixel to be adjusted according to an original pixel value of the pixel point to be adjusted in the target facial image to be processed, a current pixel value of the pixel point to be adjusted in the facial processing target image, and the target adjustment weight corresponding to the pixel to be adjusted, so as to obtain the facial processing target image corresponding to the processing degree adjustment operation.

According to one or more embodiments of the present disclosure, [Example XVIII] provides an image processing apparatus. The apparatus comprises:
an acquisition module, configured for acquiring a target facial image to be processed of a target object; and
a processing module, configured for inputting the target facial image to be processed to a pre-trained target facial processing model to obtain a facial processing target image with a target facial effect,
wherein the target facial processing model is trained by:
acquiring a plurality of reference facial images to be processed to construct a preliminary to-be-processed sample set, and acquiring a plurality of facial processing reference images with the target facial effect to construct a preliminary processing effect set;
determining a sample facial image to be processed and a facial processing sample image corresponding to the sample facial image to be processed according to the reference facial images to be processed in the preliminary to-be-processed sample set and the facial processing reference images in the preliminary processing effect set; and
training an initial facial processing model according to the sample facial image to be processed and the facial processing sample image corresponding to the sample facial image to be processed to obtain the target facial processing model.

In addition, although multiple operations are depicted in a specific order, this should not be understood as requiring these operations to be executed in the specific order shown or in a sequential order. In certain environments, multitasking and parallel processing may be advantageous. Similarly, although a plurality of implementation details are comprised in the above discussion, these should not be interpreted as limiting the scope of the present disclosure. Some features described in the context of individual embodiments may also be combined and implemented in a single embodiment. On the contrary, various features that are described in the context of the single embodiment may also be implemented in a plurality of embodiments separately or in any suitable sub-combinations.

1. An image processing method comprising:
acquiring a target facial image to be processed of a target object; and
inputting the target facial image to be processed to a pre-trained target facial processing model to obtain a facial processing target image with a target facial effect,
wherein the target facial processing model is trained by:
acquiring a plurality of reference facial images to be processed to construct a preliminary to-be-processed sample set, and acquiring a plurality of facial processing reference images with the target facial effect to construct a preliminary processing effect set;
determining a sample facial image to be processed and a facial processing sample image corresponding to the sample facial image to be processed according to the reference facial images to be processed in the preliminary to-be-processed sample set and the facial processing reference images in the preliminary processing effect set; and
training an initial facial processing model according to the sample facial image to be processed and the facial processing sample image corresponding to the sample facial image to be processed to obtain the target facial processing model.

2. The method according to claim 1, wherein determining the sample facial image to be processed and the facial processing sample image corresponding to the sample facial image to be processed according to the reference facial images to be processed in the preliminary to-be-processed sample set and the facial processing reference images in the preliminary processing effect set comprises:
training a pre-built first initial image generation model according to the reference facial images to be processed in the preliminary to-be-processed sample set to obtain an image to be processed generation model;
training a pre-built second initial image generation model according to the facial processing reference images in the preliminary processing effect set to obtain a sample effect image generation model; and
generating the sample facial image to be processed and the facial processing sample image corresponding to the sample facial image to be processed according to the image to be processed generation model and the sample effect image generation model,
wherein the first initial image generation model and the second initial image generation model are style-based generative adversarial networks.

3. The method according to claim 2, wherein generating the sample facial image to be processed and the facial processing sample image corresponding to the sample facial image to be processed according to the image to be processed generation model and the sample effect image generation model comprises:
determining a target image conversion model according to the reference facial images to be processed in the preliminary to-be-processed sample set and the image to be processed generation model, wherein the target image conversion model is used for converting an image input to the target image conversion model into a target image vector; and
generating the sample facial image to be processed according to the image to be processed generation model, and generating the facial processing sample image corresponding to the sample facial image to be processed according to the sample facial image to be processed, the target image conversion model, and the sample effect image generation model.

4. The method according to claim 3, wherein determining the target image conversion model according to the reference facial images to be processed in the preliminary to-be-processed sample set and the image to be processed generation model comprises:
inputting the reference facial images to be processed in the preliminary to-be-processed sample set to an initial image conversion model to obtain model conversion vectors;
inputting the model conversion vectors to the image to be processed generation model to obtain model-generated images corresponding to the model conversion vectors; and
performing parameter adjustment on the initial image conversion model according to a loss between the model-generated images and the reference facial images to be processed which are input to the initial image conversion model and correspond to the model-generated images, so as to obtain the target image conversion model.

5. The method according to claim 3, wherein generating the sample facial image to be processed according to the image to be processed generation model to be processed, and generating the facial processing sample image corresponding to the sample facial image to be processed according to the sample facial image to be processed, the target image conversion model, and the sample effect image generation model comprises:
inputting the reference facial images to be processed to the target image conversion model to obtain target image vectors corresponding to the reference facial images to be processed;
inputting the target image vectors to the image to be processed generation model to obtain the sample facial image to be processed; and
inputting the target image vectors to the sample effect image generation model to obtain the facial processing sample image corresponding to the sample facial image to be processed.

6. The method according to claim 2, wherein prior to training the initial facial processing model according to the sample facial image to be processed and the facial processing sample image corresponding to the sample facial image to be processed, the method further comprises:
performing image correction processing on the sample facial image to be processed or the facial processing sample image corresponding to the sample facial image to be processed, wherein the image correction processing comprises at least one of facial color correction processing, facial deformation correction processing, or facial makeup restoration processing.

7. The method according to claim 6, wherein in the event that the image correction processing comprises the facial color correction processing, performing image correction processing on the sample facial image to be processed or the facial processing sample image corresponding to the sample facial image to be processed comprises:
determining a facial skin area to be processed in the sample facial image to be processed, and determining a reference color mean value corresponding to a plurality of pixel points in the facial skin area to be processed;
determining a facial skin area to be adjusted in the facial processing sample image corresponding to the sample facial image to be processed, and determining a color mean value to be adjusted corresponding to a plurality of pixel points in the facial skin area to be adjusted; and
adjusting color values corresponding to the plurality of pixel points in the facial skin area to be adjusted according to the reference color mean value and the color mean value to be adjusted.

8. The method according to claim 6, wherein in the event that the image correction processing comprises the facial makeup restoration processing, performing image correction processing on the sample facial image to be processed or the facial processing sample image corresponding to the sample facial image to be processed comprises:
in the event that a facial area in the facial processing sample image comprises makeup information, performing makeup processing on the sample facial image to be processed corresponding to the facial processing sample image according to the makeup information.

9. The method according to claim 6, wherein in the event that the image correction processing comprises the facial deformation correction processing, performing image correction processing on the sample facial image to be processed or the facial processing sample image corresponding to the sample facial image to be processed comprises:
determining correction key points of facial areas in the sample facial image and the facial processing sample image corresponding to the sample facial image to be processed, respectively; and
adjusting a shape of the facial area in the facial processing sample image according to a position of the correction key point in the sample facial image to be processed and a position of the correction key point in the facial processing sample image.

10. The method according to claim 1, wherein the initial facial processing model comprises a processing effect generation model and a processing effect discrimination model; and training the initial facial processing model according to the sample facial image to be processed and the facial processing sample image corresponding to the sample facial image to be processed to obtain the target facial processing model comprises:
inputting the sample facial image to be processed to the processing effect generation model to obtain a processing effect generation image;
adjusting the processing effect generation model according to the sample facial image to be processed, the processing effect generation image, and the facial processing sample image corresponding to the sample facial image to be processed; and
determining, according to a discrimination result obtained by the processing effect discrimination model for the processing effect generation image, whether to stop adjusting the processing effect generation model, and using the processing effect generation model obtained at the end of the adjustment as the target facial processing model.

11. The method according to claim 10, wherein adjusting the processing effect generation model according to the sample facial image to be processed, the processing effect generation image, and the facial processing sample image corresponding to the sample facial image to be processed comprises:
determining a first facial feature loss between the sample facial image to be processed and the processing effect generation image, and determining a second facial feature loss between the processing effect generation image and the facial processing sample image corresponding to the sample facial image to be processed; and
adjusting the processing effect generation model according to the first facial feature loss and the second facial feature loss.

12. The method according to claim 1, wherein acquiring the target facial image to be processed of the target object comprises:
in response to a received processing trigger operation for generating the facial processing target image with the target facial effect, capturing the target facial image to be processed of the target object based on an image capturing device, or receiving the target facial image to be processed of the target object based on an image upload control.

13. The method according to claim 1, wherein after obtaining the facial processing target image with the target facial effect, the method further comprises:
displaying the facial processing target image in a target display area.

14. The method according to claim 13, wherein after obtaining the facial processing target image with the target facial effect, the method further comprises:
displaying an effect adjustment control for adjusting an image processing degree in the target display area; and
in response to a processing degree adjustment operation performed on the effect adjustment control being received, displaying the facial processing target image corresponding to the processing degree adjustment operation in the target display area.

15. The method according to claim 14, wherein displaying the facial processing target image corresponding to the processing degree adjustment operation in the target display area comprises:
determining a target weight corresponding to the processing degree adjustment operation, determining the facial processing target image corresponding to the processing degree adjustment operation according to the target facial image to be processed, the facial processing target image, the target weight, and a preset facial mask image, and displaying the adjusted facial processing target image in the target display area, wherein a pixel value of a facial skin area in the preset facial mask image is 1, and a pixel value of areas other than the facial skin area is 0.

16. The method according to claim 15, wherein determining the facial processing target image corresponding to the processing degree adjustment operation according to the target facial image to be processed, the facial processing target image, the target weight, and the preset facial mask image comprises:
weighting pixel values of a plurality of pixel points in the preset facial mask image according to the target weight to obtain a target adjustment weight corresponding to each of the pixel points; and
for each pixel point to be adjusted in a facial area of the facial processing target image, calculating a target pixel value of the pixel to be adjusted according to an original pixel value of the pixel point to be adjusted in the facial processing target image, a current pixel value of the pixel point to be adjusted in the facial processing target image, and the target adjustment weight corresponding to the pixel to be adjusted, so as to obtain the facial processing target image corresponding to the processing degree adjustment operation.

17. (canceled)

18. An electronic device, comprising:
at least one processor; and
a memory configured for storing at least one computer program,
wherein the at least one computer program, when executed by the at least one processor, causes the at least one processor to;
acquire a target facial image to be processed of a target object; and
input the target facial image to be processed to a pre-trained target facial processing model to obtain a facial processing target image with a target facial effect,
wherein the target facial processing model is trained by:
acquiring a plurality of reference facial images to be processed to construct a preliminary to-be-processed sample set, and acquiring a plurality of facial processing reference images with the target facial effect to construct a preliminary processing effect set;
determining a sample facial image to be processed and a facial processing sample image corresponding to the sample facial image to be processed according to the reference facial images to be processed in the preliminary to-be-processed sample set and the facial processing reference images in the preliminary processing effect set; and
training an initial facial processing model according to the sample facial image to be processed and the facial processing sample image corresponding to the sample facial image to be processed to obtain the target facial processing model.

19. A computer-readable storage medium storing a computer program, wherein the computer program, when executed by a processor, causes the processor to:
acquire a target facial image to be processed of a target object; and
input the target facial image to be processed to a pre-trained target facial processing model to obtain a facial processing target image with a target facial effect,
wherein the target facial processing model is trained by:
acquiring a plurality of reference facial images to be processed to construct a preliminary to-be-processed sample set, and acquiring a plurality of facial processing reference images with the target facial effect to construct a preliminary processing effect set;
determining a sample facial image to be processed and a facial processing sample image corresponding to the sample facial image to be processed according to the reference facial images to be processed in the preliminary to-be-processed sample set and the facial processing reference images in the preliminary processing effect set; and
training an initial facial processing model according to the sample facial image to be processed and the facial processing sample image corresponding to the sample facial image to be processed to obtain the target facial processing model.

20. (canceled)

21. The electronic device according to claim 18, wherein the at least one processor being caused to determine the sample facial image to be processed and the facial processing sample image corresponding to the sample facial image to be processed according to the reference facial images to be processed in the preliminary to-be-processed sample set and the facial processing reference images in the preliminary processing effect set comprises being caused to:
train a pre-built first initial image generation model according to the reference facial images to be processed in the preliminary to-be-processed sample set to obtain an image to be processed generation model;
train a pre-built second initial image generation model according to the facial processing reference images in the preliminary processing effect set to obtain a sample effect image generation model; and
generate the sample facial image to be processed and the facial processing sample image corresponding to the sample facial image to be processed according to the image to be processed generation model and the sample effect image generation model,
wherein the first initial image generation model and the second initial image generation model are style-based generative adversarial networks.

22. The electronic device according to claim 21, wherein the at least one processor being caused to generate the sample facial image to be processed and the facial processing sample image corresponding to the sample facial image to be processed according to the image to be processed generation model and the sample effect image generation model comprises being caused to:
determine a target image conversion model according to the reference facial images to be processed in the preliminary to-be-processed sample set and the image to be processed generation model, wherein the target image conversion model is used for converting an image input to the target image conversion model into a target image vector; and
generate the sample facial image to be processed according to the image to be processed generation model, and generating the facial processing sample image corresponding to the sample facial image to be processed according to the sample facial image to be processed, the target image conversion model, and the sample effect image generation model.
